(19) United States
(12) Patent Application Publication
(10) Pub. No.: US 2018/0238057 A1
(43) Pub. Date: Aug. 23, 2018

(54) Extended Reach Cleaning Device

(71) Applicant: Henrietta Smith, Wyandanch, NY (US)

(72) Inventor: Henrietta Smith, Wyandanch, NY (US)

(21) Appl. No.: 15/437,311

(22) Filed: Feb. 20, 2017

(51) Int. Cl. E04D 13/076; B05B 1/12; B05B 12/00

(52) U.S. Cl. CPC E04D 13/0765; B05B 12/002; B05B 1/12

(57) ABSTRACT

An extended reach cleaning device for cleaning surfaces distal from a user includes a tube that comprises a plurality of nested sections. The tube is extendable. The tube has a first end that is configured to couple to a hose. The plurality of nested sections comprises a top segment. The top segment is curved such that a flow of water through the tube exits from a second end of the tube toward the first end. The second end is configured to position proximate to surfaces distal from the first end, such as a gutter and a top of a trailer. The flow of water exiting the second end is configured to clean the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cleaning devices and more particularly pertains to a new cleaning device for cleaning surfaces distal from a user.

### BRIEF SUMMARY OF THE INVENTION

An embodiment of the disclosure meets the needs presented above by generally comprising a tube that comprises a plurality of nested sections. The tube is extendable. The tube has a first end that is configured to couple to a hose. The plurality of nested sections comprises a top segment. The top segment is curved such that a flow of water through the tube exits from a second end of the tube toward the first end. The second end is configured to position proximate to surfaces distal from the first end, such as a gutter and a top of a trailer. The flow of water exiting the second end is configured to clean the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an extended reach cleaning device according to an embodiment of the disclosure.

FIG. 2 is a front view of an embodiment of the disclosure.

FIG. 3 is a side view of an embodiment of the disclosure.

FIG. 4 is a cross-sectional view of an embodiment of the disclosure.

FIG. 5 is a cross-sectional view of an embodiment of the disclosure.

FIG. 6 is an in-use view of an embodiment of the disclosure.

### DETAILED DESCRIPTION OF THE INVENTION

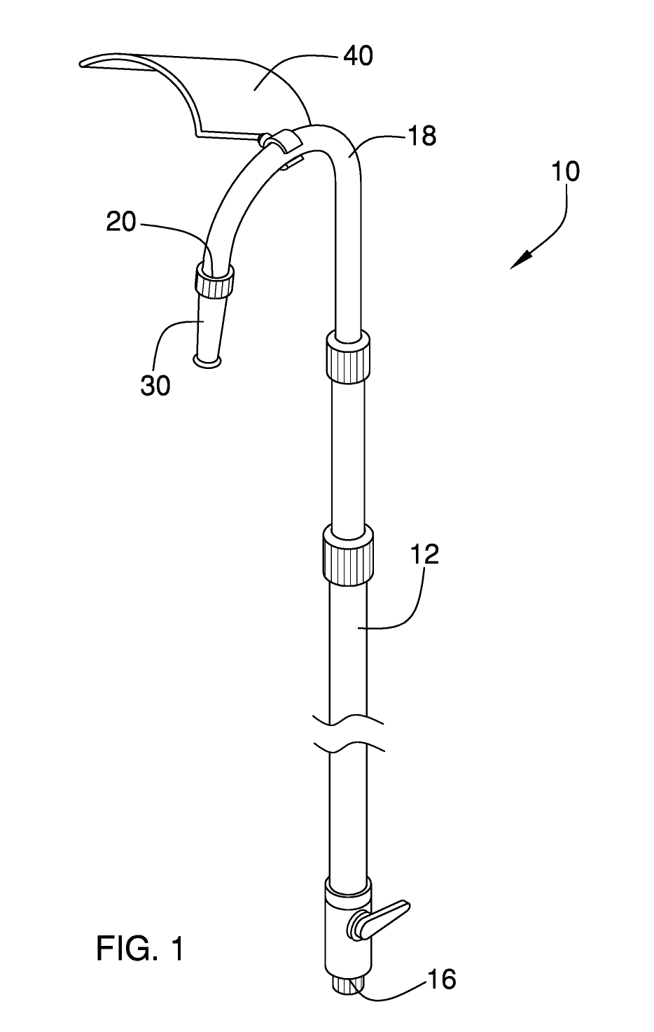

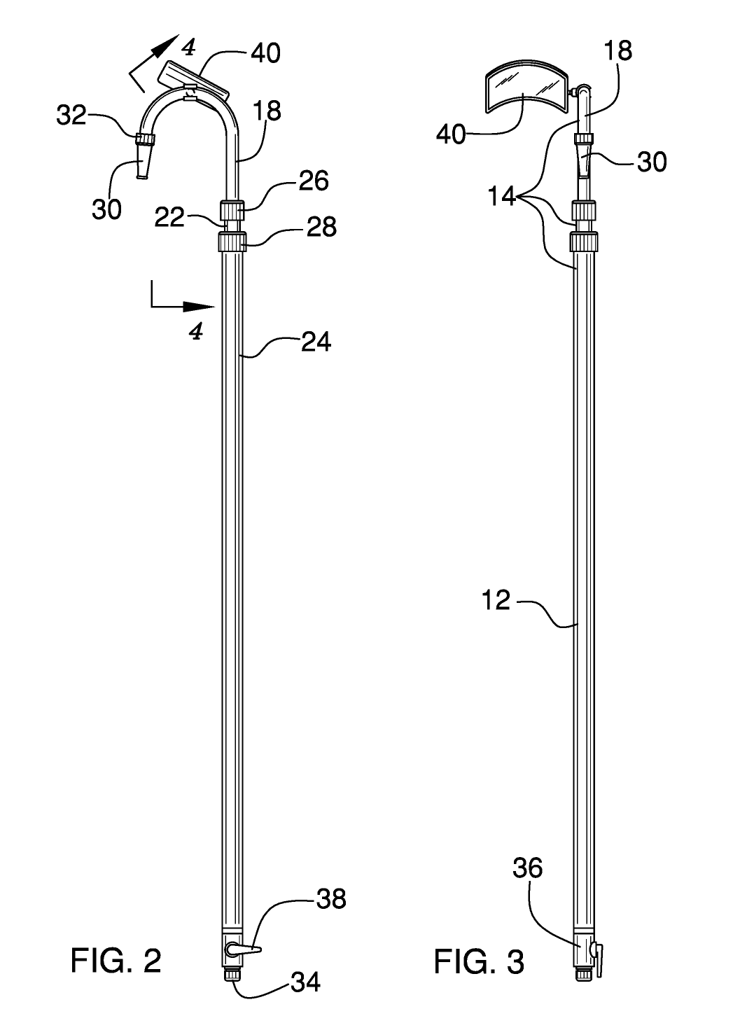

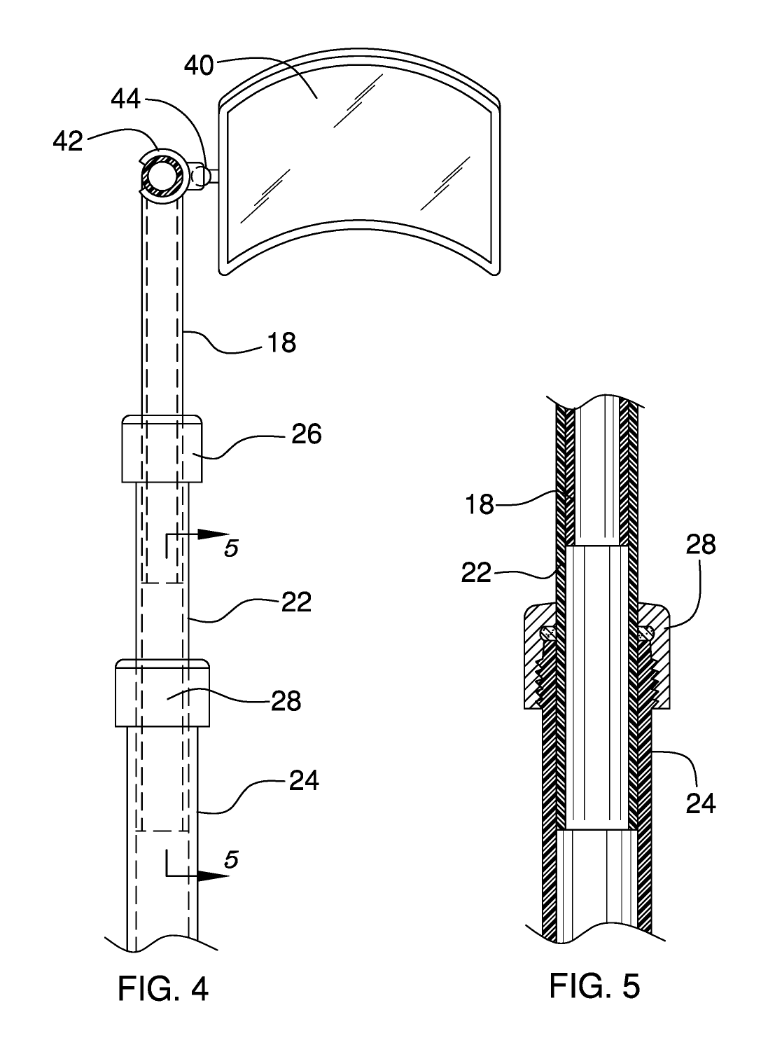

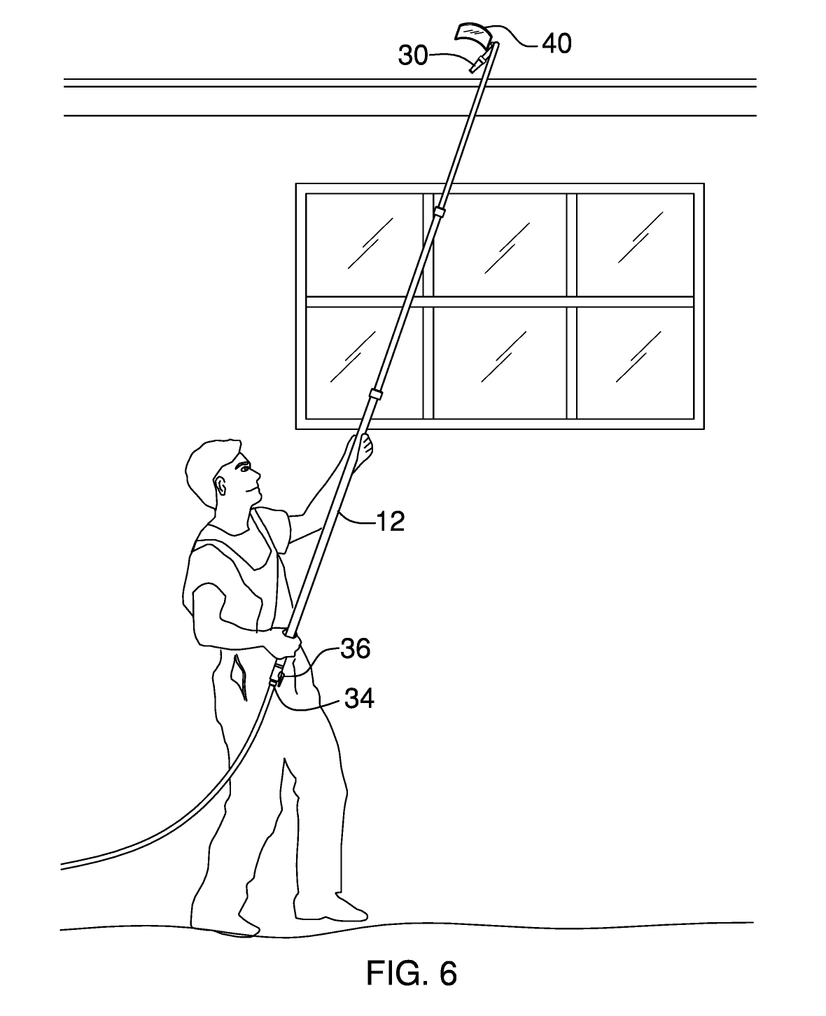

With reference now to the drawings, and in particular to FIGS. 1 through 6 thereof, a new cleaning device embodying the principles and concepts of an embodiment of the disclosure and generally designated by the reference numeral 10 will be described.

As best illustrated in FIGS. 1 through 6, the extended reach cleaning device 10 generally comprises a tube 12 that comprises a plurality of nested sections 14. The tube 12 is extendable. The tube 12 has a first end 16 that is configured to couple to a hose. The plurality of nested sections 14 comprises a top segment 18. The top segment 18 is curved such a flow of water through the tube 12 exits from a second end 20 of the tube 12 toward the first end 16. The second end 20 is configured to position proximate to surfaces distal from the first end 16, such as a gutter and a top of a trailer. The flow of water that exits the second end 20 is configured to clean the surfaces.

In one embodiment, the tube 12 is substantially circularly shaped when viewed longitudinally. In another embodiment, the plurality of nested sections 14 comprises a middle segment 22, which is slidably coupled to the top segment 18, and a bottom segment 24 that is slidably coupled to the middle segment 22.

A first fitting 26 is coupled to the top segment 18. The first fitting 26 is threadedly couplable to the middle segment 22. The first fitting 26 is positioned to adjustably couple to the middle segment 22 to couple the middle segment 22 to the top segment 18.

A second fitting 28 is coupled to the middle segment 22. The second fitting 28 is threadedly couplable to the bottom segment 24. The second fitting 28 is positioned to adjustably couple to the bottom segment 24 to couple the bottom segment 24 to the middle segment 22.

A nozzle 30 is threadedly couplable to the second end 20 of the tube 12. The nozzle 30 is configured to adjustably shape the flow of water that exits the second end 20 of the tube 12.

A third fitting 32 is coupled to the top segment 18. The third fitting 32 is threadedly couplable to the nozzle 30. The third fitting 32 is positioned to couple to the nozzle 30 to couple the nozzle 30 to the tube 12.

A coupler 34 is coupled to the first end 16 of the tube 12. The coupler 34 is complementary to a male hose fitting. The coupler 34 is configured to couple the tube 12 to the hose.

A valve 36 is coupled to and is positioned in the tube 12 proximate to the first end 16. A handle 38 is rotationally coupled to the tube 12. The handle 38 is operationally coupled to the valve 36. The handle 38 is configured to be rotated to adjustably position the valve 36 between an open setting and a closed setting. The flow of water into the tube 12 is adjustable.

A mirror 40 is adjustably coupled to the tube 12 proximate to the second end 20. The mirror 40 is configured to view the surfaces distal from the first end 16. In one embodiment, the mirror 40 is concavely arcuate.

A clamp 42 is coupled to the tube 12 proximate to the second end 20. A ball joint 44 is coupled to and extends from the clamp 42. The mirror 40 is coupled to the ball joint 44 distal from the clamp 42. The mirror 40 is configured to be selectively oriented relative to the tube 12.

In use, the coupler 34 is configured to couple the tube 12 to the hose. The handle 38 is configured to be rotated to adjustably position the valve 36 between an open setting and a closed setting. The flow of water into the tube 12 is adjustable. The third fitting 32 is positioned to couple to the nozzle 30 to couple the nozzle 30 to the tube 12. The nozzle 30 is configured to adjustably shape the flow of water that exits the second end 20 of the tube 12. The top segment 18 is curved such that the flow of water through the tube 12 exits from the nozzle 30 toward the first end 16. The mirror 40 is configured to view the surfaces distal from the first end 16, such as the gutter and the top of the trailer. The second end 20 is configured to position proximate to the surfaces. The flow of water that exits the nozzle 30 is configured to clean the surfaces.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extended reach cleaning device comprising:
a tube comprising a plurality of nested sections such that said tube is extendable, said tube having a first end configured for coupling to a hose, said plurality of nested sections comprising a top segment, said top segment being curved such that a flow of water through said tube exits from a second end of said tube toward said first end; and
wherein said tube is configured for coupling to the hose such that said second end is configured for positioning proximate to surfaces distal from said first end, such as a gutter and a top of a trailer, such that the flow of water exiting said second end is configured for cleaning the surfaces.

2. The device of claim 1, further including said tube being substantially circularly shaped when viewed longitudinally.

3. The device of claim 1, further including said plurality of nested sections comprising a middle segment slidably coupled to said top segment and a bottom segment slidably coupled to said middle segment;

4. The device of claim 1, further including a nozzle threadedly couplable to said second end of said tube, said nozzle being configured for adjustably shaping the flow of water exiting said second end of said tube.

5. The device of claim 1, further including a coupler coupled to said first end of said tube, said coupler being complementary to a male hose fitting, wherein said coupler is positioned on said tube such that said coupler is configured for coupling said tube to the hose.

6. The device of claim 1, further comprising:
a valve coupled to and positioned in said tube proximate to said first end;
a handle rotationally coupled to said tube, said handle being operationally coupled to said valve; and
wherein said handle is positioned on said tube such that said handle is configured rotating such that said valve is adjustably positionable between an open setting and a closed setting such that the flow of water into said tube is adjustable.

7. The device of claim 1, further including a mirror adjustably coupled to said tube proximate to said second end, wherein said mirror is positioned on said tube such that said mirror is configured for viewing the surfaces distal from said first end.

8. The device of claim 7, further including said mirror being concavely arcuate.

9. The device of claim 7, further comprising:
a clamp coupled to said tube proximate to said second end;
a ball joint coupled to and extending from said clamp, said mirror being coupled to said ball joint distal from said clamp; and
wherein said mirror is positioned on said ball joint such that said mirror is configured for selectively orienting relative to said tube.

10. The device of claim 4, further including a third fitting coupled to said top segment, said third fitting being threadedly couplable to said nozzle, wherein said third fitting is positioned on said top segment such that said third fitting is positioned to couple to said nozzle to couple said nozzle to said tube.

11. The device of claim 3, further comprising:
a first fitting coupled to said top segment, said first fitting being threadedly couplable to said middle segment;
a second fitting coupled to said middle segment, said second fitting being threadedly couplable to said bottom segment; and
wherein said first fitting is positioned on said top segment such that said first fitting is positioned to adjustably couple to said middle segment to couple said middle segment to said top segment, wherein said second fitting is positioned on said middle segment such that said second fitting is positioned to adjustably couple to said bottom segment to couple said bottom segment to said middle segment.

12. An extended reach cleaning device comprising:
a tube comprising a plurality of nested sections such that said tube is extendable, said tube having a first end configured for coupling to a hose, said plurality of nested sections comprising a top segment, said top segment being curved such that a flow of water through said tube exits from a second end of said tube toward said first end, wherein said tube is configured for coupling to the hose such that said second end is configured for positioning proximate to surfaces distal from said first end, such as a gutter and a top of a trailer, such that the flow of water exiting said second end is configured for cleaning the surfaces, said tube being substantially circularly shaped when viewed longitudinally, said plurality of nested sections comprising a middle segment slidably coupled to said top segment and a bottom segment slidably coupled to said middle segment;
a first fitting coupled to said top segment, said first fitting being threadedly couplable to said middle segment, wherein said first fitting is positioned on said top segment such that said first fitting is positioned to adjustably couple to said middle segment to couple said middle segment to said top segment;
a second fitting coupled to said middle segment, said second fitting being threadedly couplable to said bottom segment, wherein said second fitting is positioned on said middle segment such that said second fitting is positioned to adjustably couple to said bottom segment to couple said bottom segment to said middle segment;
a nozzle threadedly couplable to said second end of said tube, said nozzle being configured for adjustably shaping the flow of water exiting said second end of said tube;
a third fitting coupled to said top segment, said third fitting being threadedly couplable to said nozzle, wherein said third fitting is positioned on said top segment such that said third fitting is positioned to couple to said nozzle to couple said nozzle to said tube;
a coupler coupled to said first end of said tube, said coupler being complementary to a male hose fitting, wherein said coupler is positioned on said tube such that said coupler is configured for coupling said tube to the hose;
a valve coupled to and positioned in said tube proximate to said first end;
a handle rotationally coupled to said tube, said handle being operationally coupled to said valve, wherein said handle is positioned on said tube such that said handle is configured rotating such that said valve is adjustably positionable between an open setting and a closed setting such that the flow of water into said tube is adjustable;
a mirror adjustably coupled to said tube proximate to said second end, wherein said mirror is positioned on said tube such that said mirror is configured for viewing the surfaces distal from said first end, said mirror being concavely arcuate;
a clamp coupled to said tube proximate to said second end;
a ball joint coupled to and extending from said clamp, said mirror being coupled to said ball joint distal from said clamp, wherein said mirror is positioned on said ball joint such that said mirror is configured for selectively orienting relative to said tube; and
wherein said coupler is positioned on said tube such that said coupler is configured for coupling said tube to the hose, wherein said handle is positioned on said tube such that said handle is configured rotating such that said valve is adjustably positionable between the open setting and the closed setting such that the flow of water into said tube is adjustable, wherein said third fitting is positioned on said top segment such that said third fitting is positioned to couple to said nozzle to couple said nozzle to said tube such that said nozzle is configured for adjustably shaping the flow of water exiting said second end of said tube, wherein said mirror is positioned on said tube such that said mirror is configured for viewing the surfaces distal from said first end, such as the gutter and the top of the trailer, wherein said top segment is curved such that the flow of water through said tube exits from said nozzle toward said first end, such that said second end is configured for positioning proximate to the surfaces, such that the flow of water exiting said nozzle is configured for cleaning surfaces.
